(19) United States
(12) Patent Application Publication
(10) Pub. No.: US 2011/0318547 A1
(43) Pub. Date: Dec. 29, 2011

(54) THERMAL INK JET PRINTING METHOD

(75) Inventors: Linfang Zhu, Naperville, IL (US); Casey Robertson, Romeoville, IL (US)

(73) Assignee: VIDEOJET TECHNOLOGIES INC., Wood Dale, IL (US)

(21) Appl. No.: 13/254,549

(22) PCT Filed: Mar. 9, 2010
(86) PCT No.: PCT/US2010/026648

§ 371 Date: Sep. 2, 2011

Related U.S. Application Data
(60) Provisional application No. 61/159,875, filed on Mar. 13, 2009.
(60) Provisional application No. 61/159,878, filed on Mar. 13, 2009.

(51) Int. Cl. B32B 3/10; B41J 2/05

(52) U.S. Cl. 428/195.1; 347/56

(57) ABSTRACT

A method for printing a decoration image on a substrate with a thermal ink jet printer includes providing a thermal ink jet printer and providing an ink composition for the ink jet printer. The ink composition includes water and a colorant. Both the substrate and the ink are soluble or dispersible in water. Droplets of the ink composition are applied to the substrate by the thermal ink jet printer. The ink droplets are allowed to dry, thereby printing an image on the substrate.

### CROSS REFERENCE TO RELATED APPLICATIONS

This application claims priority to U.S. Provisional Application No. 61/159,875 filed Mar. 13, 2009, and No. 61/159,878 filed Mar. 13, 2009, both of which are incorporated herein by reference in their entireties.

### BACKGROUND OF THE INVENTION

Product decoration is typically accomplished through off-line printing processes such as flexographic printing, which provides excellent resolution and print quality. Off-line printing is an expensive process that requires production lines, production space and inventory management of the printed parts. It is slow and expensive to change the printing image with typical off-line printing processes. Web in-line digital printing processes such as continuous ink jet (CIJ) and thermal ink jet (TIJ) printing are advantageous over off-line printing processes. In-line digital printing processes eliminate the need for inventory of pre-printed parts, and provide easy and fast image change, as images can be pre-created with suitable software and stored in a computer. With the touch of a button, a different image can be loaded into the printer and be printed on the product.

Flexible plastic films are widely used as primary packaging materials. Fast drying solvent inks are typically needed for printing on plastic films. Due to single nozzle CIJ printers' limitations on print height and resolution, graphic images typically require the use of the binary array CIJ technology. However, the resolution of the binary array CIJ technology is typically 128 dpi, which is still too low for what is needed for product decoration.

Thermal ink jet (TIJ) print heads produce ink droplets from thermal vaporization of the ink solvent. In the jetting process, a resistor is heated rapidly to produce a vapor bubble which subsequently ejects a droplet from the orifice. This process is extremely efficient and reproducible. Modern TIJ print heads for industrial graphics applications are capable of generating uniform drops of 4 pL or smaller in volume at frequencies of 36 kHz or greater. TIJ can provide up to 600 dpi or higher resolution. TIJ is widely used for printing on paper substrates. Typical TIJ inks are water based and contain non-volatile solvent(s) to help keep the nozzle wet during non-printing periods. Such inks are not suitable for printing on non-porous substrates due to dry time and adhesion issues. Plastic substrates including plastic films present even more challenges. There is a desire for inks with attractive performance characteristics such as short dry times, long decap times and good adhesion when using a TIJ system to print onto semi-porous and non-porous substrates.

Ink opacity is often required for printing on dark and transparent substrates in order to achieve good contrast between the printed ink and its surrounding background. Typically opacity is achieved through the use of titanium dioxide (TiO₂) as the pigment. Titanium dioxide has extremely high density and tends to settle in ink jet inks. Frequent fluid agitation or circulation is required to minimize pigment sedimentation, since pigment sedimentation in the cartridge will result in nozzle clogging and poor print quality. This represents technical difficulty for thermal ink jet printing as ink cartridges used in the market today do not have ink circulation systems built in.

### BRIEF SUMMARY OF THE INVENTION

The present disclosure provides a method of using thermal inkjet printing with an ink composition to provide decorations on a plastic substrate, with suitable dry time, rub resistance, and print quality. The present disclosure further provides in-line printing methods and/or processes to print opaque inks onto non-porous flexible plastic films for product decoration.

In an embodiment, a method for printing a decoration image on a substrate with a thermal ink jet printer includes providing a thermal ink jet printer and providing an ink composition for the ink jet printer. The ink composition includes water and a colorant. Both the substrate and the ink are soluble or dispersible in water. Droplets of the ink composition are applied to the substrate by the thermal ink jet printer. The ink droplets are allowed to dry, thereby printing an image on the substrate.

### DETAILED DESCRIPTION OF THE INVENTION

The present disclosure provides a method of using thermal inkjet printing with aqueous inks to provide decorations on a plastic substrate, with suitable dry time, rub resistance, resistance to a non-aqueous detergent concentrate, print quality, and decap time.

In particular uses, it is desirable that the substrate and the ink printed upon the substrate both dissolve or disperse in an aqueous environment (for example, in a dish washer) so that the ink does not leave solid ink residues on any equipment or, for example, on the dishes. If a pigment ink is used, it is desirable that the pigment particles in the ink disperse readily in the aqueous environment and do not settle or agglomerate. It has been found that aqueous TIJ inks disclosed herein overcomes both the dry time and adhesion issues associated with TIJ inks for printing on plastic films, as well as the resolution difficulties of CIJ for product decoration. In addition, the aqueous TIJ inks disclosed meet the desired solubility or dispersibility requirement. In one embodiment, the present disclosure also provides a method of using thermal inkjet printing with a microsphere-containing ink composition to provide decorations on a plastic substrate

The present disclosure also provides in-line printing methods used to print onto non-porous flexible plastic films for product decoration. It has been discovered that water based thermal ink jet inks provide adequate dry time and adhesion when applied on to a plastic film (such as polyvinyl alcohol) using a TIJ printer. It is speculated that water molecules penetrate into the nonporous polyvinyl alcohol film, allowing the ink to dry and adhere to the surface of the film.

Product decoration has typically been accomplished through off-line printing processes such as flexographic printing. Web in-line digital printing processes such as thermal ink jet printing are advantageous over off-line printing processes, but may appear to be uneconomical compared to other printing processes. It is contemplated that thermal ink jet printing offers unrecognized advantages for product decoration of small batches or runs, and for inclusion in an in-line printing system. In-line digital printing processes eliminate the need for inventory of pre-printed parts, and provide easy and fast image change, as images can be created or modified with suitable software and stored in a computer. With the ease of selecting a decoration displayed on a computer's video display (for example, by pressing a button on a keyboard or pressing an image of the decoration on a touch screen), a different decoration can be sent via control signals to the printer and be printed on the substrate.

In typical use, the ink composition will be printed upon a substrate. As mentioned, the substrate may be a plastic film. Suitable substrates include flexible plastic films, including non-porous films, such as polyvinyl alcohol films. Other substrates comprise sheets or layers of polyester, polyethylene, polypropylene, polycarbonate, other known polyolefins, acrylic acid/polyethylene copolymers, polyethylene terephthalate, laminated paper substrates, and suitable substrates may include combinations of the foregoing materials. Suitable substrates include those useful for flexible packaging for foods, toys, detergents, and powders. The substrates may be multilayered laminates or individual layers to be later laminated to other layers.

In certain embodiments, the substrate may be a water soluble film such as polyvinyl alcohol, polyvinylpyrrolidone, carboxymethylcellulose, polymers (homopolymers and copolymers) based on acrylic acid, polymers (homopolymers and copolymers) based on methacrylic acid, and polymers (homopolymers and copolymers) based on acrylamide, and any combination thereof, and gelatin. The substrate may be a part of a consumer product, such as dishwasher soap tablets or pouches, pharmaceutical capsules, and snack food packages.

The printing may be provided in-line to print upon a moving substrate, as for example, a plastic web. The substrate may be moving at a speed of at least 80 ft/min, 100 ft/min, 200 ft/min, 220 ft/min, or faster, relative to the printer. The images may be printed using any suitable ink jet printer, preferably a thermal ink jet printer. One suitable printer is a Videojet® 4320 Printer. Other suitable printers include those using HP 45A cartridges. However, the methods disclosed herein are not limited to printers using such technology. Suitable ink compositions include water based thermal ink jet inks such as HP 1918 (available from Hewlett Packard). A typical thermal ink jet ink includes water, a colorant, a co-solvent, and a solvent with low volatility (also known as humectant). A binder resin and additives such as surfactants, biocides, dispersing agents, viscosity modifiers can be added as needed.

In a particular embodiment, the substrate is preferably water soluble, and the ink is preferably water dispersible, such that the substrate and the image printed upon it will be dissolved or dispersed when the product is subjected to an aqueous environment.

The thermal ink jet ink printing method disclosed herein may have one or more attractive features such as short unassisted dry times of printed alphanumeric or graphic images, long decap times, good adhesion to semi-porous and non-porous substrates, and safety or material compatibility with one or more components of a thermal ink jet printer. For example, embodiments of the thermal ink jet ink composition may have a dry time of about 10 seconds or less, such as 5 seconds or less, 2 seconds or less, or 1 second or less, under ambient conditions. Embodiments of the thermal ink jet ink composition may have decap times of at least 5 minutes, 10 minutes, 20 minutes, or longer. Decap time is defined as the amount of time a nozzle can remain dormant and then be fired again without detrimental effect on the droplet velocity, weight or direction.

The thermal ink jet ink composition of the invention may include any suitable colorant or colorants, which may be dye, pigment, microspheres (discussed in more detail below), or any combination of the colorants In an embodiment of the invention, the colorant is a carbon black pigment. In another embodiment of the invention, one or more dyes are employed as the colorant, wherein the one or more dyes are selected from the group consisting of acid dyes, basic dyes, direct dyes, food dyes, solvent dyes, disperse dyes, mordant dyes and any combination thereof. Examples of acid dyes are Acid Black 1, Acid Red 14, and Acid Orange 7. Examples of food colors are FD&C Blue No. 1, FD&C Blue No. 2, FD&C Green No. 3, FD&C Red No. 40, C.I. Food Blue 5, and C.I. Food Red 7. One or more colorants may be present. The colorant, dye or pigment, may be present in an amount from about 0.01% to about 10%, preferably from about 0.5% to about 7%, and more preferably from about 1% to about 5% by weight of the ink jet ink composition.

A suitable humectant may be used in the ink composition. One or more humectant may be present. Preferably, humectants have a boiling point greater than 150° C., greater than 200° C., or greater than 250° C., and/or a relative evaporation rate less than 1.0, less than 0.9, less than 0.7, less than 0.4, less than 0.1, or less than 0.01. The humectants typically are solvents having one or more polar functional groups such as hydroxyl, ether, amide, ester, ketone, and carbonate, for example, two functional groups, which may be the same or different, such as two hydroxyl groups or one hydroxyl group and one ether group. In an embodiment, the one or more humectants are selected from the group consisting of glycol, polyol, glycol ether, diacetone alcohol, 2-pyrrolidinone, N-methylpyrrolidinone, ethyl lactate, propylene carbonate, 1,3-dimethyl-2-imidazolidindione, and alkyl esters, and any combination thereof.

The thermal ink jet ink composition of the invention may include a binder resin. The binder resin may be present in any suitable amount, for example, in an amount from about 0.1 to about 10%, preferably from about 0.1 to about 5%.

In a particular embodiment of the thermal ink jet ink composition of the invention, the colorant(s) (dyes, pigments, or a combination thereof), may be present in amount from about 1% to about 8% by weight, the glycol may be present in an amount from about 3% to 20% by weight, the binder resin may be present in an amount from about 0.1% to about 5% by weight, and the additive may be present in an amount from about 0.5% to 5% by weight of the ink jet ink composition.

The additive preferably does not phase separate from the ink jet composition during application of the ink to a substrate in thermal ink jet printing. The ink composition may include a surfactant. Examples of surfactants include siloxanes, silicones, silanols, polyoxyalkyleneamines, propoxylated (poly(oxypropylene)) diamines, alkyl ether amines, nonyl phenol ethoxylates, ethoxylated fatty amines, quaternized copolymers of vinylpyrrolidone and dimethyl aminoethyl methacrylate, fluorinated organic acid diethanolamine salts, alkoxylated ethylenediamines, polyethylene oxides, polyoxyalkylene polyalkylene polyamines amines, polyoxyalkylene polyalkylene polyimines, alkyl phosphate ethoxylate mixtures, polyoxyalkylene derivatives of propylene glycol, and polyoxyethylated fatty alcohols. A specific example of a suitable polymeric surfactant, e.g., Silicone Fluid SF-69, available from Dow Corning Co, Midland, Mich., which is a blend of silanols and cyclic silicones. Additional examples of polymeric surfactants include DISPERSYBYK™ (BYK-Chemie, USA), SOLSPERSE™ (e.g., SOLSPERSE 13940 which is a polymer/fatty acid condensation polymer) and EFKA™ (EFKA Chemicals) polymeric dispersants.

The thermal ink jet ink composition of the invention may include additional ingredients such as bactericides, fungicides, algicides, sequestering agents, buffering agents, corrosion inhibitors, antioxidants, light stabilizers, anti-curl agents, thickeners, and other agents known in the relevant art.

The thermal ink jet ink composition of the invention may have any suitable viscosity or surface tension. In embodiments of the invention, the thermal ink jet ink composition has a viscosity of less than about 10 cPs, preferably less than about 5 cPs, and more preferably less than about 3 cPs, for example, a viscosity from about 1 to 4 or from about 1 to about 3 cPs at 25° C. In embodiments of the invention, the thermal ink jet ink composition has a surface tension from about 20 to about 60 mN/m.

The thermal ink jet ink composition of the invention may be prepared by any suitable method. For example, the chosen ingredients may be combined and mixed with adequate stirring and the resulting fluid filtered to remove any undissolved impurities.

In a particular embodiment, the present disclosure provides an ink composition that includes microspheres and is suitable for use in ink jet printing. Such ink compositions are disclosed in U.S. Pat. No. 4,880,465, the contents of which are hereby incorporated by reference. The ink composition preferably comprises (a) from about 2 to about 20 percent of a resin component (b) from about 5 to about 25 percent of hollow microspheres, and (c) the remainder being a suitable carrier vehicle. The carrier vehicle typically contains water, ammonium hydroxide, a volatile solvent, and a specific gravity controlling agent.

In another embodiment, the ink composition includes hollow microspheres containing a central microvoid region which is filled with liquid. The walls of the microspheres are permeable to the liquid and are comprised of a synthetic polymeric material, and have an inside diameter from about 0.1 to about 0.5 micron and an outside diameter from about 0.4 to about 1 micron. The carrier vehicle, the resin component, and the hollow microspheres are chemically non-reactive with each other and the specific gravity of the carrier vehicle is about equal to or greater than the specific gravity of the microspheres.

The ink composition including microspheres may be characterized in that after application to a suitable substrate, the liquid within the microspheres diffuses through the walls of the microspheres, leaving microvoids filled with air. Thus, the ink, upon drying, forms a coating laden with microscopic air filled microvoids which effectively scatter light incident thereupon, causing an opaque image to be produced.

The ink compositions including microspheres disclosed herein are preferably storage stable. No pigment needs be used in the present formulation and the hollow microspheres are maintained in a uniform dispersion throughout the ink, because the specific gravity of the ink carrier vehicle is about equal to the specific gravity of the hollow microspheres. Thus, the hollow microspheres do not have a tendency to settle out of the suspension or dispersion. The quality of the ink remains uniform throughout an entire printing cycle, even in the absence of any mechanical agitation or other means for mechanically maintaining the hollow microspheres in dispersion.

The hollow microspheres may be obtained commercially. Such microspheres are known in the art and may be obtained from a variety of sources. Ropaque OP-96, by Rohm and Haas Company, is a commercially available product which is an aqueous dispersion containing 40%, by weight, of hollow microspheres of an acrylic/styrene copolymer. The microspheres have an inside diameter of about 0.3 micron and an outside diameter of about 0.5 micron and are filled with water.

Such microspheres may also be prepared using the method described in U.S. Pat. No. 4,089,800, the contents of which are hereby incorporated by reference. The microspheres may be made of virtually any organic polymer and may be either thermoplastic or thermosetting. Useful thermoplastic resins of which the hollow microspheres may be formed include cellulose derivatives, acrylic resins, polyolefins, polyamides, polycarbonates, polystyrene, copolymers of styrene and other vinyl monomers, vinyl polymers such as homo- or copolymers of vinyl acetate, vinyl alcohol, vinyl chloride, vinyl butyral, and homo- and copolymers of dienes. Particularly useful thermoplastic polymers include copolymers such as 2-ethylhexylacrylate, methyl methacrylate and copolymers of styrene with other vinyl monomers such as acrylonitrile.

The present methods and systems are useful for printing one or more decorations on a substrate. The present methods and systems can include providing control signals to one or more printers, whereby the control signals instruct the printer(s) to print a decoration or a portion thereof. The present methods and systems can include a plurality of printers, each of which is loaded with a carrier having an ink of different color. A decoration comprising two or more colors can be printed on a substrate by instructing a first printer to print a first color portion of the decoration, and instructing a second printer to print a second color portion of the decoration. The first color portion and the second color portion may overlap to provide one or more colors distinct from the nominal colors.

A decoration printed using the present methods or systems may, for example, comprise or consist of one or more of the following: a figure; a picture; an artistic work; a graphic work; a photograph; a piece of intelligible text; a representation of a design; or a logo. Generally, a decoration is something other than an identification code, batch code, bar code, or expiration date, though a decoration may be configured around or cooperate with such codes or dates. Decorations are generally ornamental or artistic. It will be appreciated that this list is not exhaustive, and other forms of decoration may readily be printed using embodiments of the present methods and apparatus. Decorations for a small number of packages or for a limited time are contemplated as especially suitable for the present methods and systems. For example, holiday decorations, promotional decorations, or contest decorations may be printed in an efficient and economical manner by use of the present methods and systems.

The present methods and systems may employ a computer as a controller for one or more printers, or in communication with a separate controller. A computer (as used herein) includes any micro-processor or computing device capable of performing one or more of the functions described herein. The computer may be any suitable computer including a personal computer, a mainframe computer, or a system of networked computers. The computer preferably includes a processor for executing instructions and a memory for storing instructions, such as instructions for operating a thermal printer in response to control signals from the computer or other controller. More preferably, the computer includes a memory having instructions for operating two or more thermal printers in sequence, such that the thermal printers cooperate to print a decoration on a substrate passing through the two or more thermal printers. The memory can be a hard drive of the computer, or one or more disks, or a remote computer or server in communication with the first computer. The memory may be any suitable computing memory device, which may but need not be removable. Other suitable examples include random access memory (RAM), read only memory (ROM), video memory card such as Video Random Access memory (VRAM), flash memory, and/or any suitable removable recording media such as a floppy disk, a compact disk (CD), a digital video disk (DVD), or a thumb drive, flash drive or memory stick.

The present methods and systems optionally may comprise one or more computers in communication with one or more thermal printers. A computer may be used as the controller of the printer and may provide control signals to the printer. The components of the present methods and systems (such as the printers, controllers, feed mechanisms, in-line process equipment and other components) may be adapted for communication with each other by any suitable communication medium, standard, protocol or network such as a hardwire, a radio frequency signal, or a light signal. Some illustrative mediums, standards, protocols or networks include without limitation, hardwire, Universal Serial Bus (USB), FireWire, i.Link, IEEE 1394, ethernet, cable modem, broadband DSL, the Internet, the Public Switched Telephone Network (PSTN), intranets, Local Area Networks (LAN), Wide Area Networks (WAN), Wireless Area Network or Wireless Local Area Network (WLAN) or any other suitable communication standard, system, standard or protocol such as any Wireless Fidelity (Wi-Fi) system or network, including 802.11a, 802.11b, and 802.11g Wi-Fi systems, bluetooth systems, infrared systems, and the like.

The computer may run any suitable software including commercially available, proprietary or open source software. For example, the computer may run Windows-based software, Macintosh-based software UNIX-based software, Linux-based software or other software.

The present methods and systems can include one or more programs or software for generating or manipulating visual images or graphics on a computer. For example, a computer employed in the present systems can have graphic art software stored in its memory. Graphic art software is used for graphic design, multimedia development, specialized image development, general image editing, or simply to access graphic files. The programs or software can be capable of generating raster graphics, vector graphics, or a combination of those. The graphic art software can be employed by a user to create or modify a decoration to be printed on a substrate according to the present methods or systems.

The present methods and systems can include a suitable user interface, as part of a controller or in communication with a controller. The user input device can be a keyboard, mouse, microphone, touchpad, or other computer peripheral. The user input can be combined with a video display; for example, a touch screen may be employed to receive input and to display options and decorations.

A decoration can be digitally created and stored in a memory of the computer. The computer can include software that allows a user to create a decoration and that converts the user-generated decoration into control signals suitable for the thermal printer that instruct the thermal printer to print the decoration or a portion of the decoration. Alternatively a pre-existing decoration can be scanned or otherwise converted into a digital representation, and inputted to a computer. The computer can be used to process the digital representation into a plurality of portions of the original decoration. The various portions can be substantially separate from each other or may overlap to any desired degree. In addition to selecting the appropriate design and colors, the computer (or data or software stored on the computer or a memory) can also determine the optimal combination of color ribbons or carriers for printing the decoration.

### EXAMPLES

### Examples 1-3

This example illustrates embodiments of the thermal ink jet ink composition of the invention and their application to substrates.

Two thermal ink jet black inks were printed with text image using the Videojet® 4320 printer. The printing conditions were 300×600 dpi, line speeds of 80 ft/min and 220 ft/min, with heat assisted drying. The substrate was a polyvinyl alcohol film. The dry time, finger rub adhesion, resistance to detergent, and print quality were assessed and the results are listed in Table 1. Two black aqueous inks were used for Examples 1 and 2. The ink in Example 1 is commercially available as Videojet 16-21 ink. The ink of Example 2 is commercially available as HP 1918 ink. The samples printed in Examples 1 and 2 had acceptable dry time, adhesion, detergent resistance, and print quality with text print images when printed at low line speed.

TABLE 1

| | Dry Time | 1 min | 24 hr | Detergent | Print |
|---|---|---|---|---|---|
| Ink | (sec) | Rub | Rub | Resistance | Quality |
| Example 1 | Excellent | Good | Excellent | Good | Fair at |
| | (1 sec) | (6 rubs) | (>10 rubs) | | 220 ft/min |
| | | | | | Excellent |
| | | | | | at 80 ft/min |
| Example 2 | Excellent | Excellent | Excellent | Good | Fair at |
| | (1 sec) | (>10 rubs) | (>10 rubs) | | 220 ft/min |
| | | | | | Excellent |
| | | | | | at 80 ft/min |

Detergent resistance was tested with a cotton swap soaked with a dishwasher detergent concentrate for 10 rubs: Good=image lighter but legible; Fair=image is very light and barely legible; Poor (2)=image is illegible after 2 rubs. Dry time was determined by lightly touching the ink at various time intervals to determine the point at which the ink does not smear. Rub resistance was determined by 10 thumb rubs after 1 min and 24 hrs.

Further testing on decap time and print quality (at a line speed of 80 ft/min, printing both a text image and high coverage solid bars) were assessed with a third black, aqueous ink (Example 3) in addition to the inks of Examples 1 and 2. The results are summarized in Table 2.

TABLE 2

| Ink | Decap Time | Text Print Quality | Bar Print Quality |
|---|---|---|---|
| Example 1 | Excellent (>20 min) | Excellent | Excellent |
| Example 2 | Excellent (>20 min) | Excellent | Poor |
| Example 3 | Fair (10 min) | Excellent | Excellent |

Product to product transfer was performed with the ink of Example 1 for 24 hrs. The product to product transfer test was performed as follows. The printed images were allowed to sit for 1 hr. Another substrate was placed on top of the image. A 2 kg weight was added and allowed to sit for 24 hrs. The results were reviewed at that point to assess ink transfer and image degradation. The results for Example 1 at ambient lab conditions and in a 35° C./90% RH environmental chamber are summarized in Table 3.

TABLE 3

| | Ambient | | 35 ° C./90% RH | |
|---|---|---|---|---|
| Ink | Initial | 5 days later | Initial | 5 days later |
| Example 1 | Good | Excellent | Excellent | Excellent |

### Examples 4-5

This example illustrates embodiments of the thermal ink jet ink composition including microspheres and their application to substrates. A white ink composition (Example 4) using hollow polymer microspheres as the opaque colorant was printed with text image using a Videojet® 4320 Printer on a polyvinyl alcohol film. The printing conditions were 300×600 dpi, line speed of 80 ft/min, with heat assisted drying. The composition of the ink of Example 4 is shown below:

TABLE 4
(Example 4)

| Material | Percentage by weight |
|---|---|
| Deionized water | 43.95% |
| Foam Ban MS-575 | 0.15% |
| N-methyl-2-pyrollidine | 1.5% |
| Joncryl 682 | 10% |
| Ammonium hydroxide | 12.4% |
| (28-30% industrial grade) | |
| Ropaque OP-96 | 32% |

The ink composition of Example 4 resulted in excellent print quality for text images, and good opacity on non-porous polyvinyl alcohol film. Dry time, finger rub adhesion, and print quality were assessed and the results are listed in Table 5.

TABLE 5

| | | | Print Quality |
|---|---|---|---|
| Dry Time (sec) | 1 min Rub | 24 hr Rub | (Text) |
| Fair | Fair | Poor | Excellent |
| (25) | (3 rubs) | (1 rub) | |

From Example 4 above, it can be seen that thermal inkjet printing may be used with ink compositions containing microspheres to provide decorations on a plastic substrate, with suitable dry time and print quality.

Another suitable ink composition that may be used is set forth in Table 6 below as Example 5. The composition of Example 5 below provides a red ink. Other ink compositions may be prepared by using Keyamine Cyan liquid for a blue ink, and acid yellow and Keyamine Cyan liquid for a green ink. Other dyes may be used to provide ink compositions with the desired colors.

TABLE 6
(Example 5)

| Material | Percentage by weight |
|---|---|
| Deionized water | 43.95 |
| Foam Ban MS-575 | 0.15% |
| N-methyl-2-pyrollidine | 1.5% |
| Joncryl 682 | 10% |
| Ammonium hydroxide | 12.4% |
| (28-30% industrial grade) | |
| Ropaque OP-96 | 32% |
| Acid red 14 | 0.4% |
| FD&C Red #3 | 0.3% |
| Acid Orange 7 | 0.3% |

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein may be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A method for printing a decoration image on a substrate with a thermal ink jet printer comprising:
providing a thermal ink jet printer;
providing an ink composition for the thermal ink jet printer, wherein the ink composition comprises water and a colorant;
providing a substrate, wherein both the substrate and the ink are soluble or dispersible in water;
applying droplets of the ink composition to the substrate with the thermal ink jet printer; and
allowing the ink droplets to dry, thereby printing an image on the substrate.

2. The method of claim 1, wherein the colorant is a pigment.

3. The method of claim 2, wherein the pigment is carbon black.

4. The method of claim 1, wherein the colorant is a dye.

5. The method of claim 1 wherein the colorant comprises microspheres.

6. The method of claim 1, wherein the printing is provided in-line with a moving substrate.

7. The method of claim 6, wherein the substrate is moving at 80 ft/min or faster relative to the printer.

8. The method of claim 6, wherein the substrate is moving at 200 ft/min or faster relative to the printer.

9. The method of claim 1, wherein the ink composition has a dry time of 10 seconds or less.

10. The method of claim 1, wherein the ink composition has a dry time of 5 seconds or less.

11. The method of claim 1, wherein the ink composition has a dry time of 1 second or less.

12. The method of claim 1, wherein the ink composition has a decap time of greater than 5 minutes.

13. The method of claim 1, wherein the ink composition has a decap time of greater than 20 minutes.

14. The method of claim 1, wherein the surface of the substrate comprises a plastic film.

15. The method of claim 14, wherein the surface of the substrate comprises polyvinyl alcohol.

16. The method of claim 1, wherein the surface of the substrate is a consumer product.

17. The method of claim 1, wherein the substrate is a package for a product.

18. The method of claim 1 further comprising dissolving or dispersing the substrate and the image on the substrate in water.

19. A product packaging produced by the method of claim 1.
